(19) United States
(12) Patent Application Publication
(10) Pub. No.: US 2003/0119620 A1
(43) Pub. Date: Jun. 26, 2003

(54) Variable and differential output drive system

(75) Inventors: Edward L. Zwilling, Washington, IL (US); Michael E. Vanderham, Peoria, IL (US); Stephen E. Schuster, Peoria Heights, IL (US)

Correspondence Address: Finnegan, Henderson, Farabow,, Garrett & Dunner, L.L.P., 1300 I Street, N.W., Washington, DC, 20005-3315, US

(73) Assignee: Caterpillar Inc.

(21) Appl. No.: 10/024,313

(22) Filed: Dec. 21, 2001

(51) Int. Cl. F16H 37/02

(52) U.S. Cl. 475/219

(57) ABSTRACT

A drive system with the capability for providing continuously variable and differential outputs is provided. The drive system may include a power source system and first, second, and third variable drive units coupled to the power source system. The drive system may also include first and second planetary gear assemblies, each planetary gear assembly including a sun gear, a ring gear, a carrier, and a plurality of planetary elements. The first variable drive unit may be mechanically coupled to the first planetary gear assembly. The second variable drive unit may be mechanically coupled to the second planetary gear assembly. The third variable drive unit may be mechanically coupled to the first planetary gear assembly and to the second planetary gear assembly. The drive system may also include first and second output shafts coupled, respectively, to the first and second planetary gear assemblies.

### TECHNICAL FIELD

This invention relates generally to a drive system with the capability for providing continuously variable and differential outputs and, more particularly, to a drive system utilizing three drive units and two planetary gear sets.

### BACKGROUND

Many machines, including agricultural or industrial tractors, earth moving equipment, and trucks, have independent, or quasi-independent, wheel (and/or track) drive systems. These drive systems can provide differential outputs in response to different driving conditions. For instance, when driving around a curve, an individual wheel drive system may drive the outer wheel at a different speed from the inner wheel, thereby reducing the risk of slipping.

Also, for instance, differential torque outputs may allow traction to be maintained under both wheels even under greatly varying traction conditions.

One known way to impose differential or unequal torques between drive wheels is to resist any difference in rotation between the drive wheels, typically by braking one of the wheels. This results, however, in a loss of efficiency.

Drive systems using individual electric motors coupled to the individual output shafts are known. For example, electric motors coupled to each output shaft and controlled by a controller have been used to provide continuously variable drive systems. Continuously variable drive systems provide stepless adjustment of the wheel speed. These individual electric motors must be sized to provide the entire maximum torque, for if one wheel slips due to unfavorable traction conditions, the other wheel and its corresponding electric motor must supply the entire torque. This requirement that each motor be sized to provide the entire maximum torque results in inefficiency and makes it difficult to achieve size reduction in the assembly.

Moreover, hybrid systems, which use both an engine and an electrical generator, to power the output shafts, are known. In series hybrid systems, the engine powers the electrical generator, which in turn, powers a common drive shaft or independent output shafts. In parallel hybrid systems, the drive shaft or output shafts are alternatively driven by the engine via a mechanical transmission or by the electrical generator (or fuel cells) via the electric motors. In another known hybrid system, such as U.S. Pat. No. 5,947,855, each wheel is driven by mechanical power from the engine combined (via a “summation gear”) with power from an electrical motor associated with the wheel. This is a cumbersome system, requiring separate summation gear sets for each driven wheel, in conjunction with a mechanical transmission and change-speed gearbox.

Thus, there is a need in the drive system industry, particularly with respect to tracked machines, for compact and efficient drive systems providing continuously variable output torques and/or output speeds in conjunction with providing differential outputs. The present invention is directed to overcoming one or more of the problems or disadvantages associated with the prior art.

### SUMMARY OF THE INVENTION

In one aspect of the invention, a drive system with the capability for providing continuously variable and differential outputs is provided. The drive system may include a power source system and first, second, and third variable drive units coupled to the power source system. The drive system may also include first and second planetary gear assemblies, each planetary gear assembly including a sun gear, a ring gear, a carrier, and a plurality of planetary elements. The first variable drive unit may be mechanically coupled to the first planetary gear assembly. The second variable drive unit may be mechanically coupled to the second planetary gear assembly. The third variable drive unit may be mechanically coupled to the first planetary gear assembly and to the second planetary gear assembly. The drive system may also include first and second output shafts coupled, respectively, to the first and second planetary gear assemblies.

In another aspect of the invention, a drive system with the capability for providing continuously variable and differential outputs includes a power source system, which may include a combustion engine coupled to an electric generator. The drive system may also include first, second, and third electric drive units coupled to the electric generator and first and second planetary gear assemblies, each planetary gear assembly including a sun gear, a ring gear, a carrier, and a plurality of planetary elements. The first electric drive unit may be mechanically coupled via a first gear to the ring gear of the first planetary gear assembly. The second electric drive unit may be mechanically coupled via a second gear to the ring gear of the second planetary gear assembly. The third electric drive unit may be mechanically coupled to the sun gear of the first planetary gear assembly and to the sun gear of the second planetary gear assembly. The drive system may further include first and second output shafts coupled, respectively, to the carrier of the first planetary gear assembly and to the carrier of the second planetary gear assembly.

In a further aspect of the invention, a method for providing continuously variable and differential outputs to first and second output shafts is provided. The first and second output shafts may be coupled, respectively, to first and second planetary gear assemblies. The method may include providing a first variable drive unit coupled to the first planetary gear assembly, providing a second variable drive unit coupled to the second planetary gear assembly, and providing a third variable drive unit coupled to both the first and the second planetary gear assemblies. The method may further include operating the first drive unit to drive the first output shaft, operating the second drive unit to drive the second output shaft, and operating the third drive unit to drive the first and the second output shafts.

### BRIEF DESCRIPTION OF THE DRAWINGS

The accompanying drawings, which are incorporated in and constitute a part of this specification, illustrate exemplary embodiments of the invention and together with the description, serve to explain the principles of the invention.

FIG. 1 is a schematic illustration of an exemplary embodiment of a drive system in accordance with the invention;

FIG. 2 is a schematic illustration of another exemplary embodiment of a drive system in accordance with the invention;

FIG. 3 is a schematic illustration of another exemplary embodiment of a drive system in accordance with the invention;

FIG. 4 is a schematic illustration of another exemplary embodiment of a drive system in accordance with the invention;

FIG. 5 is a schematic illustration of another exemplary embodiment of a drive system in accordance with the invention;

FIG. 6 is a schematic illustration of another exemplary embodiment of a drive system in accordance with the invention; and

FIG. 7 is a schematic illustration of another exemplary embodiment of a drive system in accordance with the invention.

### DETAILED DESCRIPTION

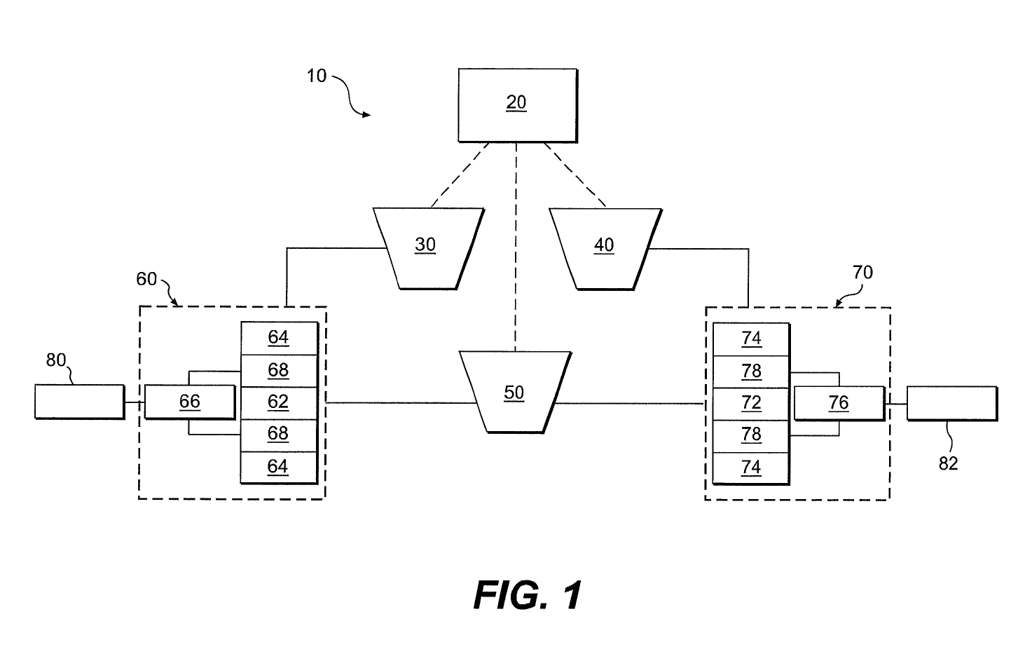

FIG. 1 is a schematic illustration of an exemplary embodiment of a drive system with the capability for providing continuously variable and differential outputs. The drive system 10 of FIG. 1 includes three variable drive units 30, 40, 50 and two planetary gear assemblies 60, 70.

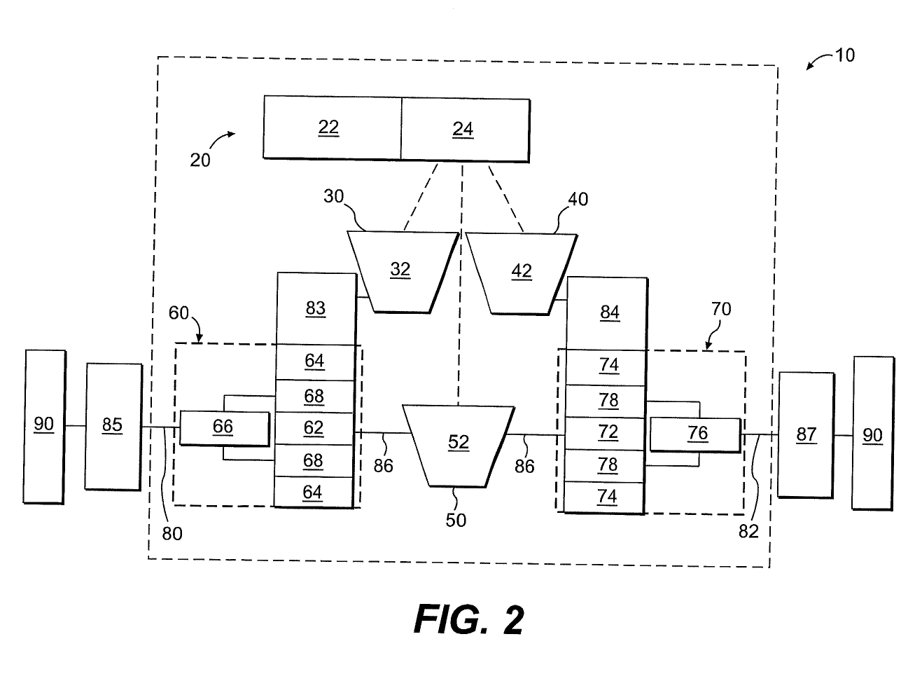

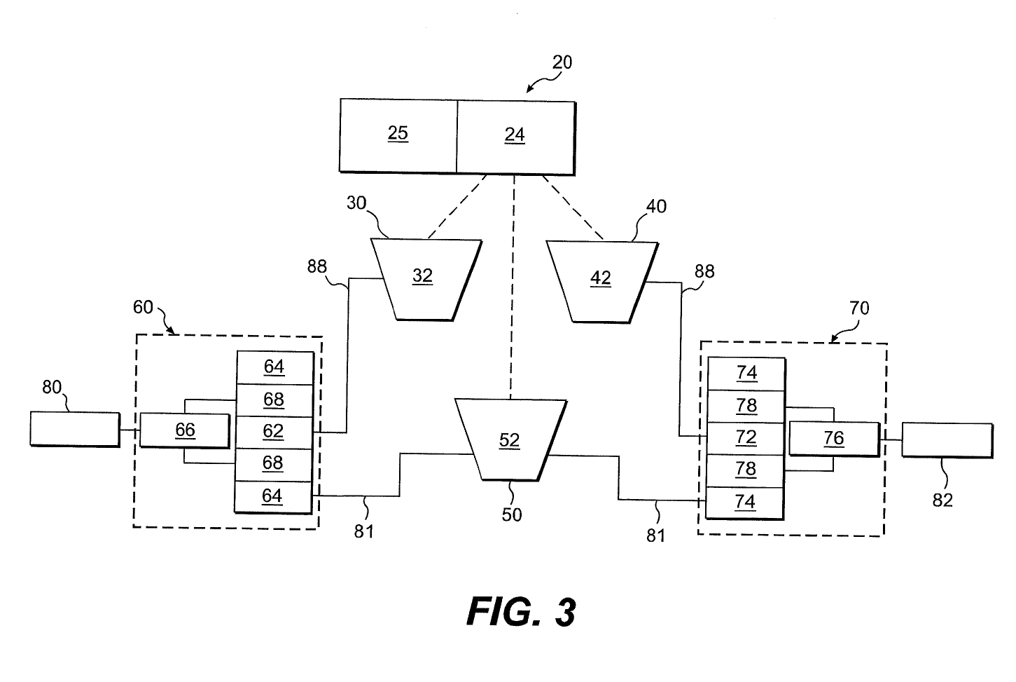

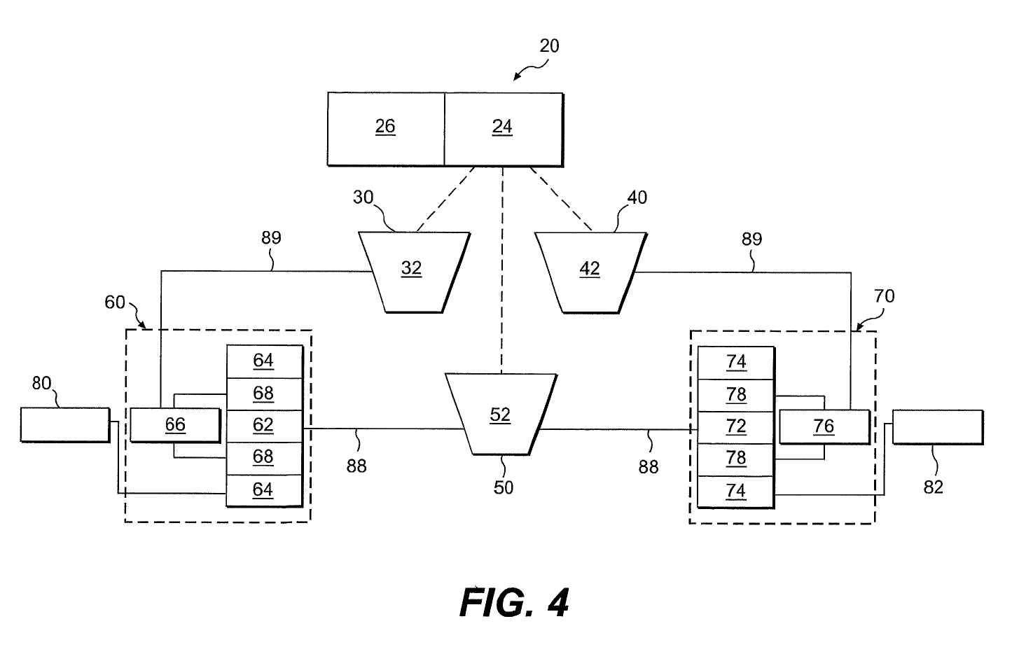

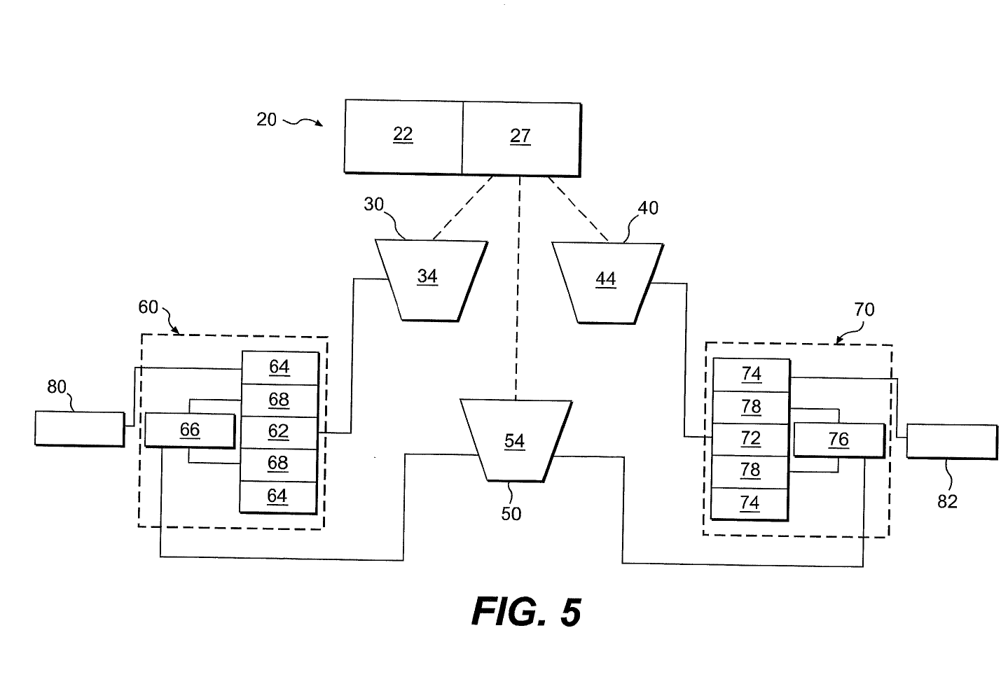

Drive system 10 includes a power source system 20 and first, second and third variable drive units 30, 40, 50 coupled to power source system 20. In one embodiment, as shown in FIG. 2, power source system 20 includes a combustion engine 22 coupled to an electric generator 24. Combustion engine 22 may be fueled by gasoline, diesel, or other alternative fuels. Electric generator 24 may be any suitable electric generator known to those of ordinary skill in the art. Alternatively, as shown in FIG. 3, power source system 20 may include a gas turbine 25 coupled to electric generator 24. Power source system 20, as shown in FIG. 4, may also include a fuel cell 26, such as, for instance, a battery, which may be rechargeable. Fuel cell 26 may or may not be coupled to electrical generator 24. Power source system 20 may be electrically connected to variable drive units 30, 40, 50. Even further, as shown in FIG. 5, power source system 20 may include a hydraulic pump 27, such as are known to those of ordinary skill in the art. Hydraulic pump 27 may be hydraulically connected to variable drive units 30, 40, 50.

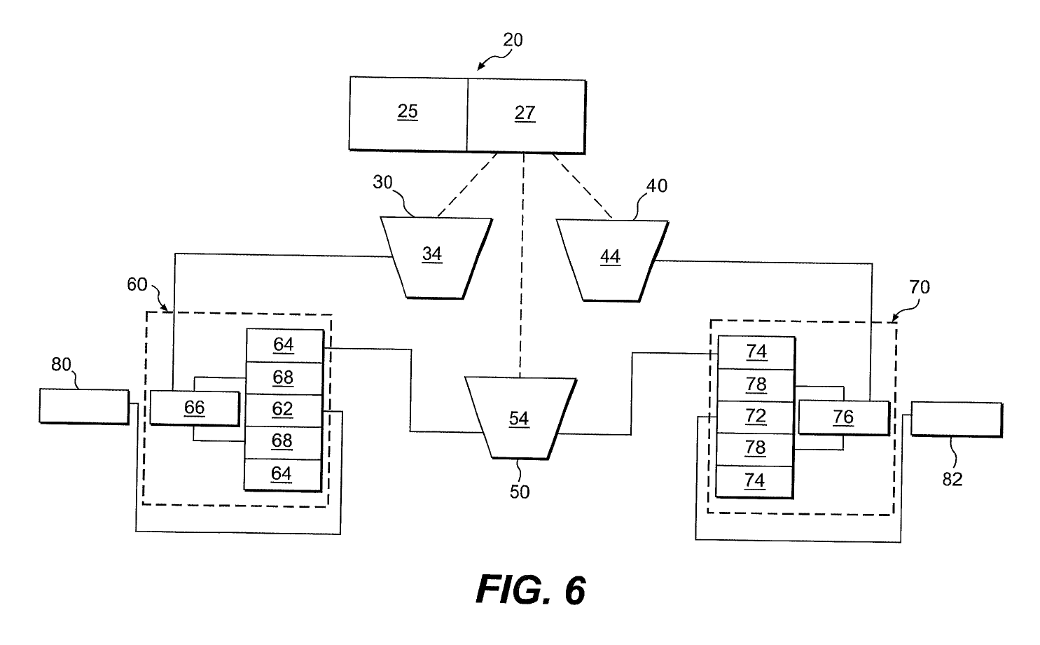

Variable drive units 30, 40, 50 may be variable electric drive units 32, 42, 52 (as shown in FIGS. 2, 3 and 4) or variable hydraulic drives 34, 44, 54 (as shown in FIGS. 5 and 6) or a combination of the two. Suitable variable drive units may be standard, off-the-shelf, drive units or drive units specially designed for the particular application. Variable electric drive units may be more efficient than variable hydraulic drives units, while variable hydraulic drives units may be more compact than variable electric drives units. Furthermore, in all of the disclosed embodiments, one or more of electrical drive units 32, 42, 52 could be substituted for one or more of hydraulic drive units 34, 44, 54, and vice versa.

Drive system 10 further includes first and second planetary gear assemblies 60, 70. As shown in FIGS. 1-7, each planetary gear assembly 60, 70 includes a sun gear 62, 72, a ring gear 64, 74, a carrier 66, 76, and a plurality of planetary elements 68, 78, respectively.

As shown in FIG. 1, first variable drive unit 30 is coupled to first planetary gear assembly 60 and second variable drive unit 40 is coupled to second planetary gear assembly 70. Third variable drive unit 50 is a common drive unit, i.e., it is coupled to both first planetary gear assembly 60 and to second planetary gear assembly 70.

Also, as shown in FIG. 1, first and second planetary gear assemblies 60, 70 are coupled, respectively, to first and second output shafts 80, 82. Output shafts 80, 82 may be directly or indirectly attached to drive tracks or wheels. For instance, output shafts 80, 82 may be coupled, respectively, to final drives 85, 87, as shown in FIG. 2, which may, in turn, be coupled to tracks 90. Final drives 85, 87 may be speed reduction final drives, such as, for instance, double reduction final drives. Final drives may also be speed increasing final drives.

The use of three drive units, including common variable drive unit 50, allows the torque capability of the drive units to be more efficiently distributed compared to a drive system having a single independent drive unit associated with each output shaft. Moreover, as described below, when the output torque values of the output shafts 80, 82 are opposite in sign, this drive system may provide for mechanical power regeneration from one output to the other output. In addition, also as described below, under certain operating conditions, the first or second variable drive units 30, 40 may feed power back to the power source system 20.

Variable drive units 30, 40, 50 and output shafts 80, 82 may be coupled to the elements of the planetary gear assemblies 60, 70 in any of several configurations. While a number of such configurations are depicted in the drawings, one skilled in the art would understand that other configurations may be possible. The specific configuration will depend upon the application and will take into account, for instance, the ratings of the drive units, the physical parameters of the planetary gear assemblies, and the output operating requirements.

For example, in one embodiment, as shown in FIG. 2, electric drive unit 32 is mechanically coupled to ring gear 64. This mechanical coupling may, for instance, include a gear 83, as shown in FIG. 2, or other coupling means systems. Similarly, electric drive unit 42 is mechanically coupled to ring gear 74 also via a gear 84 or other means. Thus, electric drive units 32, 42 may rotatably drive ring gears 64, 74 within the drive unit's speed and torque capabilities. Also as shown in FIG. 2, electric drive unit 52, the common drive unit, is coupled to both sun gear 62 and sun gear 72. Electric drive unit 52 may be coupled to sun gears 62, 72, for instance, via a direct connection, such as shafts 86. Alternatively, a gear system (not shown) may connect electric drive unit 52 to sun gears 62, 72. Output shafts 80, 82 are coupled, respectively, to carriers 66, 76. The exemplary embodiment shown in FIG. 2 typically provides a speed reduction capability coupled with a relatively high torque capability at the output shafts. Moreover, the embodiment of FIG. 2 may be relatively easy to assemble.

Drive units 30, 40, and 50 may be coupled to the components of planetary gear assemblies 60, 70 in any of a variety of ways. For instance, by way of example only and depending upon the configuration of drive system 10, drive unit 30 may be coupled to ring gear 64 or to sun gear 62 or to carrier 66 via a gear 83, such as a spur gear, a helical gear, or other suitable gear, a gearing system 88, a chain drive 81, a friction drive 89, such as a belt drive, or any combination of these. Similarly, drive unit 40 may be coupled to ring gear 74, sun gear 72, or carrier 76 and drive unit 50 may be coupled to ring gears 64, 74, sun gears 62, 72, or carriers 66, 76 via these same mechanisms. Furthermore, the couplings between the drive units and the components of the planetary gear assemblies 60, 70 need not be limited to any particular speed ratio, but could encompass reduction ratios, increasing ratios, or even a one-to-one ratio. This may provide an added measure of flexibility, as the choice of speed ratio could affect the sizing of the drive units. Moreover, removably coupling the drive units to the components of the planetary gear assemblies may provide a further flexibility in that speed ratios between the drive units and the corresponding planetary gear assembly components could easily be changed by changing the speed ratio of the coupling.

In another exemplary embodiment, as shown in FIG. 3, electric drive units 32, 42 are coupled, respectively, to sun gears 62, 72 via a gear system 88, causing the sun gears to be rotatably driven. Of course, it is understood that a direct shaft connection is also possible. Electric drive unit 52 is coupled to ring gear 64 and ring gear 74. As in the embodiment of FIG. 2, output shafts 80, 82 are coupled, respectively, to carriers 66, 76.

In even another exemplary embodiment, as shown in FIG. 4, electric drive units 32, 42 are coupled, respectively, to carriers 66, 76. Common electric drive unit 52 is coupled to sun gears 62, 72. Output shafts 80, 82 are coupled, respectively, to ring gears 64, 74.

In a further exemplary embodiment, as shown in FIG. 5, hydraulic drive units 34, 44 are coupled, respectively, to sun gears 62, 72. Common hydraulic drive unit 54 is coupled to carriers 66, 76. As in the embodiment of FIG. 4, output shafts 80, 82 are coupled, respectively, to ring gears 64, 74.

In a still further exemplary embodiment, as shown in FIG. 6, hydraulic drive units 34, 44 are coupled, respectively, to carriers 66, 76. Common hydraulic drive unit 54 is coupled to ring gears 64, 74. Output shafts 80, 82 are coupled, respectively, to sun gears 62, 72.

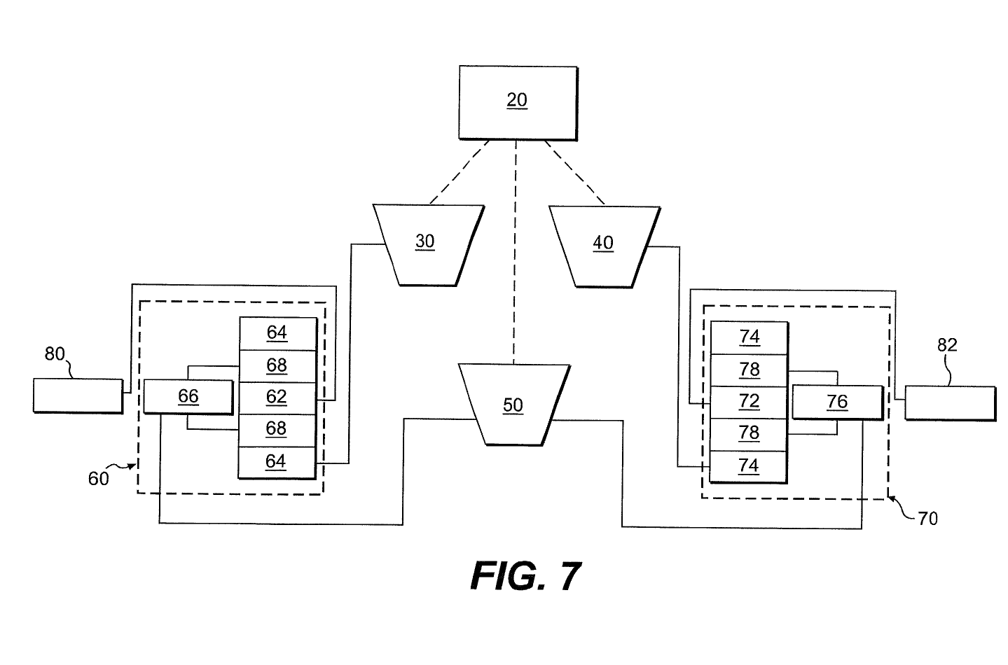

In another exemplary embodiment, as shown in FIG. 7, drive units 30, 40 are coupled, respectively, to ring gears 64, 74. Common drive unit 50 is coupled to carriers 66, 76. As in the embodiment of FIG. 6, output shafts 80, 82 are coupled, respectively, to sun gears 62, 72. Coupling the output shafts to the sun gears typically results in a relatively high speed output.

### INDUSTRIAL APPLICABILITY

The drive system of FIG. 1 may be adapted for use on wheeled or tracked machines. In particular, the drive system of FIG. 1 may be especially suited for use in agricultural tractors or earthmoving dozers.

One exemplary use of the invention could be in an agricultural tractor that is provided with combustion engine 22 coupled to electric generator 24. Referring now to FIG. 2, first, second, and third variable electric drive units 32, 42, 52 may be electrically coupled to the electric generator 24 and to first and second planetary gear assemblies 60, 70. Spur gear 83 may be used to mechanically couple first variable electric drive unit 32 to ring gear 64 of first planetary gear assembly 60. Similarly, another spur gear 84 may be used to mechanically couple second variable electric drive unit 42 to ring gear 74 of second planetary gear assembly 70. A drive shaft 86 may mechanically couple the third variable electric drive unit 52 to the sun gears 62, 72 of both the first and second planetary gear assemblies 60, 70. First and second output shafts 80, 82 may be coupled, respectively, to carriers 66, 76 of the first and second planetary gear assemblies 60, 70 at their first ends and coupled to final drives 85, 87 at their second ends. Final drives 85, 87 may, in turn, be coupled to left- and right-side tracks 90 of the agricultural tractor.

The use of three drive units efficiently distributes the power capability of the tractor. This concept is illustrated in the following example. Assume that the peak power requirement is 100 horsepower. In order to meet this requirement, a tractor having only one-drive-unit-per-each-output-shaft system would need to have each drive unit sized to provide the full 100 horsepower, for the situation where one of the tracks slips and thereby fails to transmit power. Thus, the total horsepower that must be provided by the two drive units is 200, when the peak horsepower requirement is only half that amount. In the present invention, the first and second drive units could be sized to provide, for example, 40 horsepower each, and the third drive unit, i.e., the common drive unit, could be sized to provide 60 horsepower. Then, when one of the tracks slips, the common drive unit could supply all of its 60 horsepower to the non-slipping track already being provided with 40 horsepower from the non-slipping track's not-in-common drive unit. The peak power requirement of 100 horsepower is provided to the non-slip track, and the total horsepower provided in the drive system is a more efficient 140 horsepower.

Referring again to FIG. 2, under certain operating conditions, i.e., when the torques of the sun gears 62, 72 are opposite in sign, the use of common electric drive unit 52 may provide for mechanical power regeneration from one output to the other output. This is because common electric drive unit 52 provides a torque to each sun gear, or put another way, the torque provided by electric drive unit 52 is the sum of the output torque of sun gear 62 and the output torque of sun gear 72. Thus, when the output torque of both sun gears are of the same sign, say for instance, sun gear 62 has an output torque of 10 foot-pounds and sun gear 72 has an output torque of 15 foot-pounds, electric drive unit 52 must supply a total torque of 25 foot-pounds. When the torque of the sun gears 62, 72 are opposite in sign, say for instance, sun gear 62 has an output torque of negative 5 foot-pounds and sun gear 72 has an output torque of 15 foot-pounds, electric drive unit 52 must now only supply a torque of 10 foot-pounds. In essence, the required output torque of 15 foot-pounds of sun gear 72 is supplied in part by electric drive unit and in part by the negative torque of sun gear 62 via the mechanical connections between the sun gears 62, 72.

Drive system 10 may be controlled such that variable electric drive units 32, 42, 52 provide the same output speed to first and second output shafts 80, 82. However, the drive system may also provide different output speeds to output shafts 80, 82. The speed of each output shaft, for instance, output shaft 80, is a function of both the speed of sun gear 62 driven by the common variable electric drive unit 52 and the speed of ring gear 64 driven by the not-in-common variable electric drive unit 32, i.e., the drive unit that is coupled to ring gear 64. Thus, the output speeds of the output shafts may be varied by, for instance, varying the speed of the common drive unit 52, which controls the speed of both sun gears 62, 72, or by, for instance, varying the speed of one or both of the not-in-common drive units 32, 42, which control the speed of one or both of the ring gears 64, 74. By running first ring gear 64 at a first speed and second ring gear 74 at a second speed, for instance, less than the first speed, the speed of first output shaft 80 will be greater than the speed of second output shaft 82.

This speed differential will cause the tractor provided with this drive system, to turn toward the side with the track turning at the slower speed.

In this manner, the tractor may be powered through turns. The greater the speed differential, the tighter the turn.

In addition, under certain operating conditions, the first or second variable electric drive units 32, 42 may feed power back to the electric generator 24 of power source system 20. This power regeneration may occur when sun gear 62 is operating at a positive torque value and a positive speed value, and when ring gear 64, also operating at a positive torque value, is operating at a negative speed value. In this case, the power associated with sun gear 62 is positive, but the power associated with ring gear 64 is negative. The negative power output of ring gear 64, in turn, drives electric drive unit 32 and, in essence, converts electric drive unit 32 into a generator feeding power back to electric generator 24.

It will be readily apparent to those skilled in this art that various changes and modifications of an obvious nature may be made to the disclosed invention, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

What is claimed is:

1. A drive system with the capability for providing continuously variable and differential outputs, the drive system comprising:
a power source system;
first, second, and third variable drive units coupled to the power source system;
first and second planetary gear assemblies, each planetary gear assembly including a sun gear, a ring gear, a carrier, and a plurality of planetary elements;
the first variable drive unit mechanically coupled to the first planetary gear assembly;
the second variable drive unit mechanically coupled to the second planetary gear assembly;
the third variable drive unit mechanically coupled to the first planetary gear assembly and to the second planetary gear assembly; and
first and second output shafts coupled, respectively, to the first and second planetary gear assemblies.

2. The drive system of claim 1, wherein the power source system is one of a fuel cell, a combustion engine coupled to an electrical generator, a gas turbine coupled to an electrical generator, a combustion engine coupled to a hydraulic pump, and a gas turbine coupled to a hydraulic pump.

3. The drive system of claim 1, wherein each of the first, second and third variable drive units are one of an electrical drive unit and a hydraulic drive unit.

4. The drive system of claim 1, wherein the third variable drive unit is mechanically coupled to the first and second planetary gear assemblies via one of a direct shaft, a gearing system, a chain drive, a friction drive, and a combination thereof.

5. The drive system of claim 1, wherein the first and second variable drive units are coupled, respectively, to the ring gears of the first and second planetary gear assemblies.

6. The drive system of claim 5, wherein the third variable drive unit is coupled to either the sun gears or the carriers of the first and second planetary gear assemblies.

7. The drive system of claim 1, wherein the first and second variable drive units are coupled, respectively, to the sun gears of the first and second planetary gear assemblies.

8. The drive system of claim 7, wherein the third variable drive unit is coupled to either the ring gears or the carriers of the first and second planetary gear assemblies.

9. The drive system of claim 1, wherein the first and second variable drive units are coupled, respectively, to the carriers of the first and second planetary gear assemblies.

10. The drive system of claim 9, wherein the third variable drive unit is coupled to either the sun gears or the ring gears of the first and second planetary gear assemblies.

11. The drive system of claim 1, wherein the first output shaft is coupled to one of the carrier, the sun gear, and the ring gear of the first planetary gear assembly, and the second output shaft is coupled to the corresponding one of the carrier, the sun gear, and the ring gear of the second planetary gear assembly.

12. A drive system with the capability for providing continuously variable and differential outputs, the drive system comprising:
a power source system including a combustion engine coupled to an electric generator;
first, second, and third electric drive units coupled to the electric generator;
first and second planetary gear assemblies, each planetary gear assembly including a sun gear, a ring gear, a carrier, and a plurality of planetary elements;
the first electric drive unit mechanically coupled via a first gear to the ring gear of the first planetary gear assembly;
the second electric drive unit mechanically coupled via a second gear to the ring gear of the second planetary gear assembly;
the third electric drive unit mechanically coupled to the sun gear of the first planetary gear assembly and to the sun gear of the second planetary gear assembly; and
first and second output shafts coupled, respectively, to the carrier of the first planetary gear assembly and to the carrier of the second planetary gear assembly.

13. The drive system of claim 12, further including a first and second final drive, the first and second output shafts being coupled, respectively, to the first and second final drives.

14. The drive system of claim 13, wherein the first and second final drives are each coupled to one of a track and a wheel.

15. The drive system of claim 12, wherein the third electric drive unit is coupled via a direct shaft to the sun gears of the first and second planetary gear assemblies.

16. A drive system with the capability for providing continuously variable and differential outputs, the drive system comprising:
a power source system including a combustion engine coupled to an electric generator;
first, second, and third electric drive units coupled to the electric generator;
first and second planetary gear assemblies, each planetary gear assembly including a sun gear, a ring gear, a carrier, and a plurality of planetary elements;
the first electric drive unit coupled to the sun gear of the first planetary gear assembly;
the second electric drive unit coupled to the sun gear of the second planetary gear assembly;
the third electric drive unit coupled to the ring gear of the first planetary gear assembly and to the ring gear of the second planetary gear assembly; and
first and second output shafts coupled, respectively, to the carrier of the first planetary gear assembly and to the carrier of the second planetary gear assembly.

17. The drive system of claim 16, further including a first and second final drive, the first and second output shafts being coupled, respectively, to the first and second final drives.

18. The drive system of claim 16, wherein the first electric drive unit is coupled via a direct shaft to the sun gear of the first planetary gear assembly, the second electric drive unit is coupled via a direct shaft to the sun gear of the second planetary gear assembly, and the third electric drive unit is coupled to the ring gears of the first and second planetary gear assemblies via first and second gearing systems.

19. A method for providing continuously variable and differential outputs to first and second output shafts coupled, respectively, to first and second planetary gear assemblies, the method comprising:
providing a first variable drive unit coupled to the first planetary gear assembly;
providing a second variable drive unit coupled to the second planetary gear assembly;
providing a third variable drive unit coupled to both the first and the second planetary gear assemblies;
operating the first drive unit to drive the first output shaft;
operating the second drive unit to drive the second output shaft; and
operating the third drive unit to drive the first and the second output shafts.
